(19) United States
(12) Patent Application Publication
(10) Pub. No.: US 2004/0249616 A1
(43) Pub. Date: Dec. 9, 2004

(54) Resource modeler system and method

(76) Inventors: Stephanie A. Vierus, Plano, TX (US); John A. Hall, Durham, NC (US); David J. Irish, Pleasanton, CA (US); Hsing-Ying Lin, Richardson, TX (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/414,792

(22) Filed: Apr. 16, 2003

(51) Int. Cl. G06F 7/60; G06F 17/10

(52) U.S. Cl. 703/2

(57) ABSTRACT

A resource modeler system comprises a processor adapted to receive a desired time period for completing a processing task and a library having information associated with a plurality of processor speeds. The system also comprises a modeler adapted to determine a quantity of cycles for each of the processor speeds corresponding to the desired time period and a quantity of cycles for each of the processor speeds corresponding to completion of the processing task. The modeler is further adapted to compare the determined quantities of cycles to select one of the plurality of processor speeds for completing the processing task within the desired time period.

### TECHNICAL FIELD OF THE INVENTION

The present invention relates generally to the field of computer systems and, more particularly, to a resource modeler system and method.

### BACKGROUND OF THE INVENTION

Computer systems are generally available with a wide variety of system resources. For example, processors are available in a variety of processing speeds, and memory resources are available in a variety of capacities and types. Thus, a practically endless number of computer system configurations may be provided by combining the different resource components.

However, selecting each of the system resources to optimize operating efficiency, minimize cost, and meet specific customer application requirements is generally a difficult task. For example, for a particular application, a particular processor speed and memory capacity may be optimally combined such that operating efficiency is maximized while the cost of the system is minimized. Presently, selecting system resources for optimum efficiency and minimal cost generally includes rule-of-thumb determinations and assumptions regarding the amount of information to be processed. However, limiting the factors to broad generalizations and assumptions generally results in improper selection of the optimum system components.

### SUMMARY OF THE INVENTION

In accordance with one embodiment of the present invention, a resource modeler system comprises a processor adapted to receive a desired time period for completing a processing task and a library having information associated with a plurality of processor speeds. The system also comprises a modeler adapted to determine a quantity of cycles for each of the processor speeds corresponding to the desired time period and a quantity of cycles for each of the processor speeds corresponding to completion of the processing task. The modeler is further adapted to compare the determined quantities of cycles to select one of the plurality of processor speeds for completing the processing task within the desired time period.

In accordance with another embodiment of the present invention, a resource modeler method comprises receiving a desired time period for completing a processing task and determining a quantity of cycles for each of a plurality of processor speeds corresponding to the desired time period. The method also comprises determining a quantity of cycles for each of the plurality of processor speeds to complete the processing task and comparing the determined quantity of cycles for completing the task to the determined quantity of cycles corresponding to the desired time period for selecting one of the plurality of processor speeds for completing the processing task within the desired time period.

### BRIEF DESCRIPTION OF THE DRAWINGS

For a more complete understanding of the present invention and the advantages thereof, reference is now made to the following descriptions taken in connection with the accompanying drawings in which:

FIG. 1 is a block diagram illustrating an embodiment of a resource modeler system in accordance with the present invention; and

FIGS. 2A and 2B are a flow diagram illustrating an embodiment of a resource modeler method in accordance with the present invention.

### DETAILED DESCRIPTION OF THE DRAWINGS

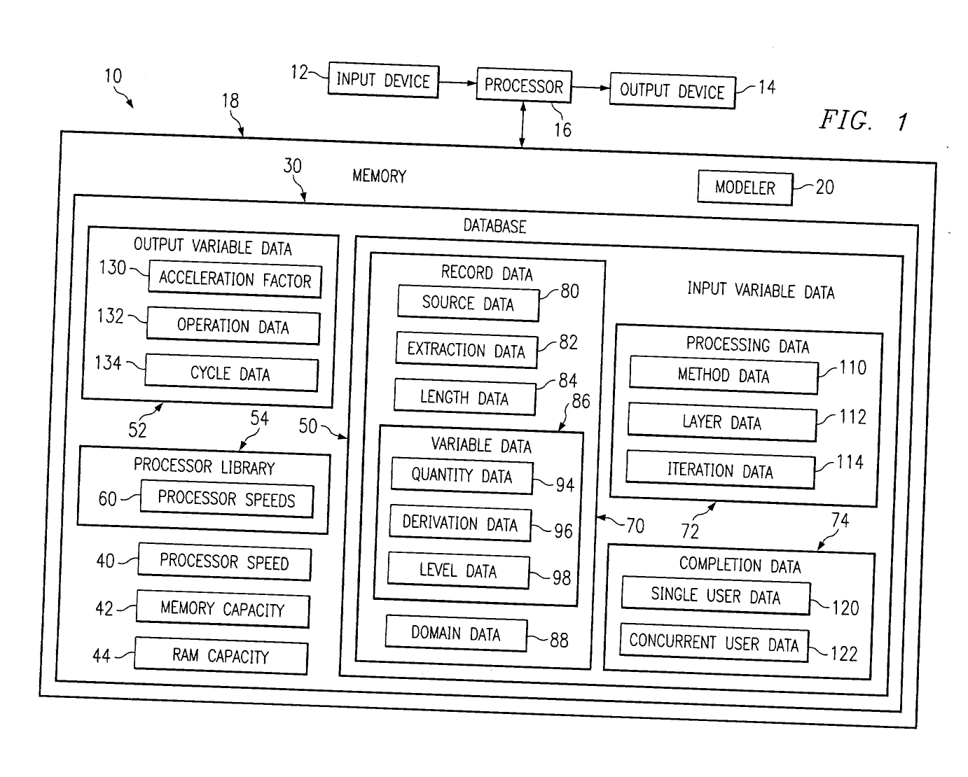

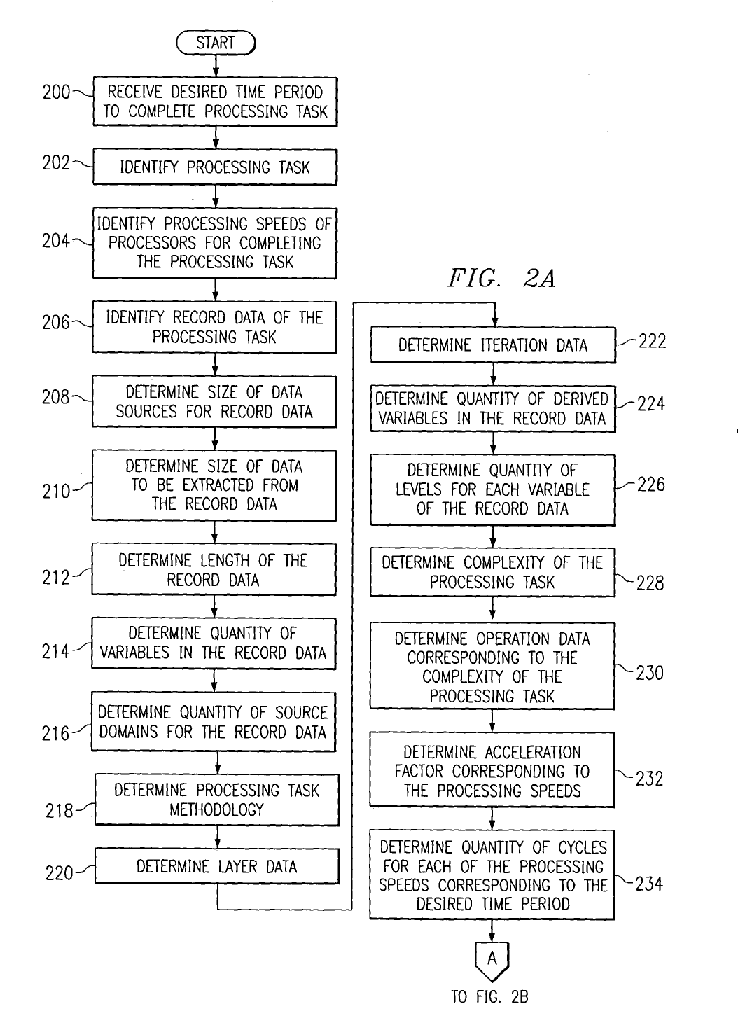

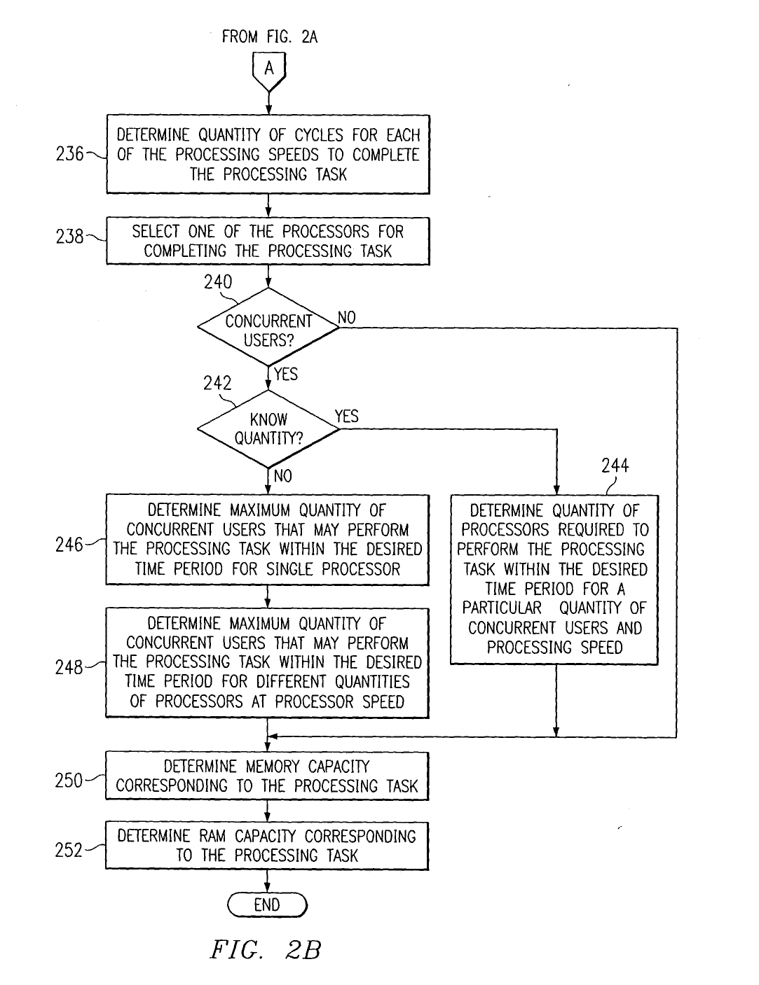

The preferred embodiments of the present invention and the advantages thereof are best understood by referring to FIGS. 1 and 2 of the drawings, like numerals being used for like and corresponding parts of the various drawings.

FIG. 1 is a diagram illustrating an embodiment of a resource modeler system 10 in accordance with the present invention. Briefly, system 10 automatically determines the optimum processor speed and/or memory capacity of a computer system for completing a processing task within a desired time period. For example, system 10 may evaluate various criteria to determine an optimum processor speed and/or memory capacity for the processing task such as, but not limited to, the complexity of the processing task; the quantity of sources from which data may be retrieved; the quantity, length, and/or complexity of variables within the processed data; and the method of data manipulation.

In the embodiment illustrated in FIG. 1, system 10 comprises an input device 12, an output device 14, a processor 16, and a memory 18. Input device 12 may comprise a keyboard, key pad, pointing device, such as a mouse or a track pad, or other type of device for inputting information into system 10. Output device 14 may comprise a monitor, display, printer, or other type of device for generating an output.

The present invention also encompasses computer software that may be executed by processor 16. In the illustrated embodiment, memory 18 comprises a modeler 20, which is a computer software program. However, it should be understood that system 10 and, specifically, modeler 20, may be configured using hardware, software, or a combination of hardware and software components. In the embodiment illustrated in FIG. 1, modeler 20 is illustrated as being stored in memory 18, where it may be executed by processor 16. However, modeler 20 may be otherwise stored, including remotely stored, as to be accessible by processor 16.

In the illustrated embodiment, system 10 also comprises a database 30 stored in memory 18. Database 30 comprises information associated with designing or modeling resources for a computer system. For example, in the illustrated embodiment, system 10 may be used to model computer system resources such as a processor speed 40, a memory capacity 42, and a random access memory (RAM) capacity 44 corresponding to completing a particular processing task within a desired time period. In the illustrated embodiment, the processing task is configured as a data mining operation; however, it should be understood that system 10 may be otherwise configured for designing system resources in connection with a variety of different types of processing tasks.

In the embodiment illustrated in FIG. 1, database 30 comprises input variable data 50, output variable data 52, and a processor library 54. Processor library 54 comprises information associated with a plurality of available processor speeds 60 for a computer system. Briefly, input variable data 50 comprises information associated with the processing task such that modeler 20 may determine the complexity of the processing task for determining the system resources required to perform the processing task within a desired time period. Output variable data 52 comprises information associated with correlating values or other algorithm-based determinations for determining system resources required to perform the processing task within a desired time period.

In the embodiment illustrated in FIG. 1, input variable data 50 comprises record data 70, processing data 72, and completion data 74. Record data 70 comprises information associated with data to be calculated, extracted, or otherwise manipulated during the processing task. For example, in the illustrated embodiment, record data 70 comprises source data 80, extraction data 82, length data 84, variable data 86, and domain data 88. Source data 80 comprises information associated with a source of the record data 70. For example, in a data mining application, source data 80 may comprise information associated with a size of a data source from which record data 70 will be extracted for manipulation during performance of the processing task. Extraction data 82 comprises information associated with the data extracted from the data source. For example, in a data mining application, extraction data 82 may comprise a size of the record data 70 to be extracted from at least one data source. Length data 84 comprises information associated with a length of the record data 70 retrieved from a data source.

Variable data 86 comprises information associated with variables within record data 70. For example, in a data mining application, variable data 86 may comprise information associated with searching and/or mining criteria. In the embodiment illustrated in FIG. 1, variable data 86 comprises quantity data 94, derivation data 96, and level data 98. Quantity data 94 comprises information associated with the number or quantity of variables used as data searching or mining criteria. Derivation data 96 comprises information associated with the number or quantity of components of a particular variable that may require derivation or otherwise require determination from a source variable. For example, a variable corresponding to a time period may also include components corresponding to a particular day, a particular hour, a particular minute, and a particular fraction of a second. Level data 98 comprises information associated with a complexity of a particular variable. For example, the determination of a particular variable may require various levels of computations such that additional processing time may be required for extracting the requested information. Domain data 88 comprises information associated with the quantity of data sources from which record data 70 will be extracted. For example, in a data mining application, domain data 88 may comprise a numeral or other factor representing the quantity of different locations from which record data 70 will be extracted such as, but not limited to, the various units of a company (i.e., manufacturing, finance, program management, and design).

Processing data 72 comprises information associated with a methodology used for the processing task. For example, in the embodiment illustrated in FIG. 1, processing data 72 comprises method data 110, layer data 112, and iteration data 114. Method data 110 comprises information associated with methods used for completing the processing task. For example, in a data mining application, method data 110 may comprise information associated with data mining techniques such as, but not limited to, neural, tree, regression, and other manipulation or searching or data manipulation methodologies. Layer data 112 may comprise information associated with the complexity of a particular processing methodology. For example, in a neural application, layer data 112 may comprise information associated with a quantity of layers for a neural mining application. Iteration data 114 comprises information associated with a quantity of iterations a particular processing methodology may require. For example, in a neural mining application, iteration data 114 may comprise information associated with a quantity of iterations performed during the processing task.

Completion data 74 comprises information associated with completing the processing task within a particular or desired time period. For example, in the embodiment illustrated in FIG. 1, completion data 74 comprises single user data 120 and concurrent user data 122. Single user data 120 comprises information associated with completing the processing task within a desired time period for a single user. Concurrent user data 122 comprises information associated with completing the processing task within the desired time period for a plurality of concurrent users requesting performance of the processing task. The desired time period may be received from a user of system 10 via input device 12 and stored in single user data 120 and/or concurrent user data 122.

Output variable data 52 comprises information associated with derived information by modeler 20 and/or information associated with the complexity of the processing task. For example, in the embodiment illustrated in FIG. 1, output variable data 52 comprises an acceleration factor 130, operation data 132, and cycle data 134. Acceleration factor 130 comprises information associated with correlating processor speeds 60 to a baseline processor speed to normalize processor speeds 60 to a baseline processing speed. Operation data 132 comprises information associated with the complexity of the processing task. For example, in a data mining application, operation data 132 may comprise a derived number representing the total number of operations performed during a processing task. Thus, operation data 132 may represent a quantity of machine operations, software operations, and/or algorithm operations reflecting a complete life cycle of a data mining application. Cycle data 134 comprises information associated with a quantity of processor cycles. For example, cycle data 134 may comprise information associated with a quantity of cycles for a particular processor speed 60 to perform a particular function.

In operation, modeler 20 uses input variable data 50 and output variable data 52 to determine computer system resources such as processor speed 40, memory capacity 42, and random access memory (RAM) capacity 44 for completing a processing task within a desired time period. For example, system 10 may receive a desired time period from a user of system 10 via input device 12 and store the desired time period as single user data 120 in memory 18. System 10 may also receive information associated with a quantity of concurrent users that may be requesting performance of a particular processing task. Thus, system 10 may also receive the quantity of concurrent users from a user of system 10 via input device 12 and store the quantity of concurrent users as concurrent user data 122. Additionally, a desired time period for performing the processing task for a plurality of concurrent users may also be stored as concurrent user data 122.

To select at least one of a plurality of processors for completing the processing task, modeler 20 determines a quantity of cycles for each processor speed 60 corresponding to the desired time period. For example, modeler 20 may determine acceleration factor 130 corresponding to each processor speed 60. As described above, acceleration factor 130 may comprise a factor normalizing processor speeds 60 to a baseline processor speed 60 reflecting latency factors corresponding to each processor speed 60. Modeler 20 may combine acceleration factor 130 with each processor speed 60 to determine a quantity of cycles for each processor speed 60 corresponding to the desired time period. The quantity of cycles determined may be stored as cycle data 134.

Modeler 20 also determines a level of complexity associated with the processing task to determine processor speed 40, memory capacity 42, and/or RAM capacity 44. The complexity of the processing task is derived by evaluating one or more of input variable data 50. For example, method data 110 may be evaluated to determine the methodology used in the processing task, such as regression, neural, or other information processing techniques. Additionally, in a data mining application, modeler 20 may evaluate other factors such as sampling ratios, variable transformations, or other information associated with the processing task. Modeler 20 may also evaluate record data 70 to determine the complexity associated with the processing task. For example, modeler 20 may evaluate the size of the data source from which record data 70 may be extracted. Modeler 20 may also evaluate the size of record data 70 to be extracted from the data source. Modeler 20 also may evaluate the length of a particular record data 70 as represented by length data 84.

Modeler 20 may also evaluate variable data 86 to determine a complexity associated with the processing task. For example, modeler 20 may evaluate the quantity of variables in a particular record data 70 as represented in quantity data 94. Modeler 20 may also evaluate the quantity of variables that may require derivation as represented by derivation data 96 and the quantity of levels or variable computations as represented by level data 98. Additionally, modeler 20 may evaluate the quantity of data sources from which the record data 70 will be extracted as represented by domain data 88.

Modeler 20 may also determine the quantity of operations for a particular processing task and store the information as operation data 132. Modeler 20 may combine operation data 132 with one or more components of input variable data 50 to determine the quantity of cycles for each of the processor speeds 60 to perform the processing task. The quantity of cycles for each processor speed 60 to complete the processing task may be stored as cycle data 134. Thus, after determining cycle data 134, modeler 20 may select one of the processor speeds 60 for completing the processing task within the desired time period. For example, modeler 20 may compare the quantity of cycles for each processor speed 60 corresponding to the desired time period with the quantity of cycles for each processor speed 60 corresponding to completion of the processing task. Based on the comparison, modeler 20 identifies at least one processor speed 60 for completing the processing task within the desired time period and selects the corresponding processor speed 40 as an optimum processor speed for completing the processing task within the desired time period.

Modeler 20 may also determine a maximum quantity of concurrent users that may request completion of the processing task within the desired time period for the selected processor speed 40. For example, modeler 20 may select a plurality of different processor speeds 60 each of which may be capable of completing the processing task within the desired time period. However, as the quantity of concurrent users requesting performance of the processing task increases, one or more processors and corresponding processor speeds 60 may require a time period greater than the desired time period for completing the processing task. Thus, modeler 20 may determine a maximum quantity of concurrent users that may complete the processing task within the desired time period for each of a plurality of processor speeds 60. Additionally, for a single processor speed 60, modeler 20 may determine the maximum quantity of concurrent users that may request completion of the processing task within the desired time period.

An example embodiment or methodology for determining an optimum processor speed for performing a processing task within a desired time period according to the present invention is summarized below:

INPUT VARIABLES˜T# & AF

OUTPUT VARIABLES˜TL=time limit, in cycles, for each central processing unit (CPU).

T#=Desired time period for completing a processing task for one user in minutes (user defined).

AF=Acceleration Factor. Benchmarking may be accomplished using a particular processor speed, (e.g., a 552 MHz machine). Thus, the acceleration factor is a value used to scale up or down for the other suitable processors. Since SAS is a floating-point application SPECfp_rate2000 can be used to create a ratio to scale up or down the speed of a CPU. Note: Specfp_rate2000 is a standard and recognized benchmark all vendors use. In the table below, 552 MHz is used as the baseline.

| | | AF |
|---|---|---|
| CPU(MHz) | SPECfp_rate2000 | ratio |
| 400 | 4.15 | 0.826693227 |
| 500 | 5.1 | 1.015936255 |
| 550 | 4.36 | 0.868525896 |
| 552 | 5.02 | 1 |
| 750 | 5.4929017 | 1.094203526 |

TL=(Benchmarked Processor Speed)(Acceleration Factor)(T#)(60)=(cycles/sec)(constant)(min)(sec/min)=cycles=552E6 * AF * T# *60

Thus, in this example, a different TL is calculated for each processor entry.

The total time (TT) for completing a processing task depends largely on the complexity of the processing task. For example, a data mining application may comprise the functions of selecting data, exploring data, modifying data, modeling data (e.g., regression, trees, and/or neural network) and assessing data (SEMMA). A model may be derived for each functional component of SEMMA by applying regression or other methodologies to the information gathered through benchmarking, thereby providing an estimate of the amount of time for completing a user-defined processing task. A conversion-unit may be used to relate or compare TL's units of cycles to SEMMA's estimate of time and account for latency. The conversion unit may be derived by creating a benchmark to illustrate the throughput of the processor such as, but not limited to, running the benchmark with varied numbers of variables and observations:

Count=size of data being accessed via read and write (bytes)

B_Elapsed Time=the run-time of the benchmark (seconds)

Clock Rate=552 MHz

Using this information the conversion-unit may be derived using the following formula:

Conversion-unit=((Clock Rate) *(B_Elapsed time))/(Count)

The benchmarking data units of time may be converted into units of cycles. For example, below is an illustrative example of converting the modeling data function of SEMMA (e.g., a regression method):

1.) Time estimate model for regression can be denoted with R_Elapsed Time

2.) Convert Time unit into Count unit

a. ((Clock Rate)*(R_Elapsed Time))/Conversion-unit

b. ((Clock Rate)*(R_Elapsed Time))/(((Clock Rate) *(B_Elapsed time))/(Count))

c. Units cancel out into count (both *_Elapsed Times are in seconds)

3.) The above step 2 may be applied to various models of SEMMA and the results combined. Additional formulas that may be used to establish a data mining life cycle from beginning to end may be: processing original input data (P1); processing original data into merged output data (P2); and transformation of variables (T). The above step 2 may be applied to additional models and combined as follows:

a. S+E+M+M+A+P1+P2+T

4.) The result of step 3 above establishes a count for the entire user-defined data mining application from beginning to end.

5.) Convert Count into Cycles

a. Count * Conversion-unit

b. Count * ((Clock Rate) *(B_Elapsed time))/(Count)

c. Units cancel out into

i. ((Clock Rate) *(B_Elapsed time))

d. Clock Rate can also be represented as cycles/second

i. (Cycles/Second)* (B_Elapsed time)

e. Since B_Elapsed time is in seconds, the units cancel out into Cycles. This number represents the total time (TT) in terms of cycles of the data mining application. Thus, because TL and TT are both in units of cycles, TT and TL may be compared to each other to determine the optimum CPU speed by determining which TL value best matches a particular TT value.

Modeler 20 may also determine a quantity of processors required at a particular processor speed 60 for completing the processing task within the desired time period. For example, modeler 20 may access concurrent user data 122 to determine the quantity of concurrent users that may request performance of the processing task. Modeler 20 may also access cycle data 134 to determine information corresponding to the quantity of cycles for completing the processing task in combination with the quantity of concurrent users requesting performance of the processing task. Thus, modeler 20 determines a quantity of processors required to complete the processing task within the desired time period for a particular processor speed 60 corresponding to a particular quantity of concurrent users.

FIG. 2 is a flow chart illustrating an embodiment of a resource modeler method in accordance with the present invention. The method begins at block 200, where system 10 receives a desired time period for completing a processing task. For example, system 10 may receive the desired time period from a user of system 10 via input device 12. At block 202, modeler 20 identifies the particular processing task to be completed. For example, system 10 may be configured such that computer system resources may be designed for completing a data mining processing task or a variety of different types of processing tasks. Thus, system 10 may be configured such that a user of system 10 may have the option of selecting one of a variety of different types of processing tasks.

At block 204, modeler 20 accesses processor library 54 and identifies the various processor speeds 60 available for completing the processing task. At block 206, modeler 20 identifies record data 70 corresponding to the processing task. At block 208, modeler 20 accesses source data 80 to determine a size of the data source having record data 70 to be used for completing the processing task. At block 210, modeler 20 accesses extraction data 82 to determine a size of the record data 70 to be extracted from the source data. At block 212, modeler 20 accesses length data 84 to determine an estimated length of the record data 70.

At block 214, modeler 20 accesses quantity data 94 to determine a quantity of variables in the record data 70. At block 216, modeler 20 accesses domain data 88 to determine a quantity of data sources for retrieving the record data 70. At block 218, modeler 20 accesses processing data 72 to determine the methodology to be used for completing the processing task. For example, as described above, the methodology for a particular processing task may include a variety of different types of data manipulation techniques, such as neural, regression, or other data processing methods. At block 220, modeler 20 accesses layer data 112 to determine a quantity of layers for the processing methodology. At block 222, modeler 20 accesses iteration data 114 to determine a quantity of iterations corresponding to the processing methodology. At block 224, modeler 20 accesses derivation data 96 to determine a quantity of derived variables for the record data 70. At block 226, modeler 20 accesses level data 98 to determine a quantity of levels for each of the variables of the record data 70.

At block 228, modeler 20 determines a complexity of the processing task. For example, as described above, modeler 20 evaluates various information of input variable data 50 to determine a complexity of the processing task for determining computer system resources. At block 230, modeler 20 determines operation data 132 corresponding to the complexity of the processing task. For example, as described above, modeler 20 may determine information representing the total number of operations performed during completion of the processing task. However, modeler 20 may also determine other information associated with the complexity of the processing task. At block 232, modeler 20 determines an acceleration factor 130 for each of the processor speeds 60.

At block 234, modeler 20 determines a quantity of cycles for each of the processor speeds 60 corresponding to the desired time period. At block 236, modeler 20 determines a quantity of cycles for each of the processor speeds 60 corresponding to completion of the processing task. At block 238, modeler 20 compares the quantity of cycles determined at blocks 234 and 236 and selects at least one of the processor speeds 60 for completing the processing task.

At decisional block 240, a determination is made whether concurrent users will be requesting completion of the processing task. If concurrent users will not be requesting completion of the processing task, the method proceeds from block 240 to block 250. If concurrent users will be requesting completion of the processing task, the method proceeds from block 240 to decisional block 242, where a determination is made corresponding to the quantity of concurrent users. If the quantity of concurrent users that will be requesting completion of the processing task is known, the method proceeds from block 242 to block 244, where modeler 20 determines a quantity of processors required to perform the processing task within the desired time period for a particular quantity of concurrent users corresponding to a particular processor speed 60. If the quantity of concurrent users is unknown, the method proceeds from block 242 to block 246, where modeler 20 determines a maximum quantity of concurrent users that may perform the processing task within the desired time period for a particular processor speed 60. At block 248, modeler 20 determines a maximum quantity of concurrent users that may perform the processing task within the desired time period for different quantities of processors at a particular processor speed 60.

At block 250, modeler 20 determines memory capacity 42 required for completing and storing information corresponding to the processing task. At block 252, modeler 20 determines RAM capacity 44 corresponding to completing and storing information associated with the processing task.

Thus, system 10 determines computer system resources such as processor speed 40, memory capacity 42, and RAM capacity 44 required for completing a processing task within a particular time period. System 10 may select various system resources to accommodate a single user or a plurality of concurrent users. Additionally, system 10 may identify a maximum quantity of concurrent users that may complete a particular processing task within the desired time period for particular processor speeds 60. Thus, system 10 optimizes efficiency while minimizing system cost.

It should be understood that in the described method, certain blocks may be omitted, combined, or accomplished in a sequence different than depicted in FIG. 2. For example, modeler 20 may be configured to evaluate particular components of input variable data 50 or may evaluate each of the components of input variable data 50 to determine a complexity associated with the processing task. Also, it should be understood that the methods depicted may be altered to encompass any of the other features or aspects of the invention as described elsewhere in the specification.

What is claimed is:

1. A resource modeler system, comprising:
a processor adapted to receive a desired time period for completing a processing task;
a library having information associated with a plurality of processor speeds; and
a modeler adapted to determine a quantity of cycles for each of the processor speeds corresponding to the desired time period and a quantity of cycles for each of the processor speeds corresponding to completion of the processing task, the modeler further adapted to compare the determined quantities of cycles to select one of the plurality of processor speeds for completing the processing task within the desired time period.

2. The system of claim 1, wherein the modeler is further adapted to determine a quantity of processors at the selected processor speed required for completing the processing task in the desired time period.

3. The system of claim 1, wherein the modeler is adapted to, for a plurality of concurrent users performing the processing task, select one of the plurality of processor speeds for completing the processing task in the desired time period.

4. The system of claim 1, wherein the modeler is further adapted to, for a plurality of concurrent users performing the processing task, determine a quantity of processors at the selected processor speed required for completing the processing task in the desired time period.

5. The system of claim 1, wherein the modeler is adapted to determine a complexity of the processing task.

6. The system of claim 1, wherein the modeler is adapted to determine the quantity of cycles for each of the processor speeds to complete the processing task using record data associated with the processing task.

7. The system of claim 1, wherein the modeler is adapted to determine a maximum quantity of concurrent users performing the processing task in the desired time period for the selected processor speed.

8. The system of claim 1, wherein the modeler is further adapted to determine a memory capacity corresponding to the processing task.

9. The system of claim 1, wherein the modeler is further adapted to determine a random access memory (RAM) capacity corresponding to the processing task.

10. The system of claim 1, wherein the modeler is further adapted to determine an acceleration factor for each of the plurality of processor speeds relating each of the processor speeds to a baseline processor speed.

11. The system of claim 1, wherein the modeler selects one of the plurality of processor speeds for completing the processing task within the desired time period.

12. The system of claim 1, wherein the modeler is adapted to select one of the plurality of processor speeds for completing the processing task within the desired time period based on a quantity of data sources requiring access to complete the processing task.

13. The system of claim 1, wherein the modeler is adapted to select one of the plurality of processor speeds for completing the processing task within the desired time period based on a quantity of variables associated with the processing task.

14. The system of claim 1, wherein the modeler is adapted to select one of the plurality of processor speeds for completing the processing task within the desired time period based on a method of data manipulation for completing the processing task.

15. The system of claim 1, wherein the modeler is adapted to select one of the plurality of processor speeds for completing the processing task within the desired time period based on a quantity of variables associated with the processing task.

16. The system of claim 1, wherein the modeler is adapted to select one of the plurality of processor speeds for completing the processing task within the desired time period based on a length of a variable of the processing task.

17. A resource modeler method, comprising:
receiving a desired time period for completing a processing task;
determining a quantity of cycles for each of a plurality of processor speeds corresponding to the desired time period;
determining a quantity of cycles for each of the plurality of processor speeds to complete the processing task; and
comparing the determined quantity of cycles for completing the task to the determined quantity of cycles corresponding to the desired time period for selecting one of the plurality of processor speeds for completing the processing task within the desired time period.

18. The method of claim 17, further comprising determining a maximum quantity of concurrent users that may perform the processing task in the desired time period for the selected processor speed.

19. The method of claim 17, further comprising determining a quantity of processors for completing the processing task in the desired time period for the selected processor speed.

20. The method of claim 17, further comprising determining a memory capacity corresponding to the processing task.

21. The method of claim 17, further comprising determining a random access memory (RAM) capacity corresponding to the processing task.

22. The method of claim 17, further comprising determining a complexity of the processing task.

23. The method of claim 17, further comprising determining an acceleration factor relating each of the processor speeds to a baseline processor speed.

24. The method of claim 17, further comprising evaluating record data associated with the processing task.

25. The method of claim 17, further comprising selecting one of the plurality of processor speeds for completing the processing task within the desired time period.

26. The method of claim 17, further comprising determining a quantity data resources to be accessed to complete the processing task.

27. The method of claim 17, further comprising determining a quantity of variables associated with the processing task.

28. The method of claim 17, further comprising determining a data manipulation method associated with completing the processing task.

29. The method of claim 17, further comprising determining a variable length associated with the processing task.

30. A resource modeler system, comprising:
means for receiving a desired time period for completing a processing task;
means for determining a quantity of cycles for each of a plurality of processor speeds corresponding to the desired time period;
means for determining a quantity of cycles for each of the plurality of processor speeds corresponding to completing the processing task; and
means for comparing the determined quantities of cycles for selecting one of the plurality of processor speeds for completing of the processing task within the desired time period.

31. The system of claim 30, further comprising means for determining a memory capacity corresponding to the processing task.

32. The system of claim 30, further comprising means for determining a random access memory (RAM) capacity corresponding to the processing task.

33. The system of claim 30, further comprising means for determining a maximum quantity of concurrent users that may perform the processing task in the desired time period for the selected processor speed.

34. The system of claim 30, further comprising means for determining a complexity associated with the processing task.

35. The system of claim 30, further comprising means for determining an acceleration factor relating each of the plurality of processor speeds to a baseline processor speed.

36. The system of claim 30, further comprising means for evaluating record data corresponding to the processing task.

37. The system of claim 30, further comprising means for determining a quantity of processors at the selected processor speed for completing the processing task within the desired time period.

38. The system of claim 30, further comprising means for determining a data manipulation method associated with completing the processing task.

39. The system of claim 30, further comprising means for selecting one of the plurality of processor speeds for completing of the processing task within the desired time period.

40. The system of claim 30, further comprising means for determining a quantity of variables associated with the processing task.

41. The system of claim 30, further comprising means for determining a quantity of variables associated with the processing task.

42. The system of claim 30, further comprising means for determining a length of at least one variable associated with the processing task.

43. A resource modeler system, comprising:
a processor adapted to receive a desired time period for completing a processing task;
a library having information associated with a plurality of processor speeds; and
a modeler adapted to determine a quantity of processors required for completing the processing task within the desired time period using at least one of the plurality of processor speeds.

44. The system of claim 43, wherein the modeler is further adapted to determine a maximum quantity of concurrent users that may complete the processing task within the desired time period for the at least one of the processor speeds.

45. The system of claim 43, wherein the modeler is further adapted to determine a memory capacity associated with the processing task.

46. The system of claim 43, wherein the modeler is further adapted to determine a random access memory (RAM) capacity associated with the processing task.

47. The system of claim 43, wherein the modeler is adapted to evaluate record data associated with the processing task to determine the quantity of processors.

48. The system of claim 43, wherein the modeler is adapted to determine a complexity of the processing task for determining the quantity of processors.

49. The system of claim 43, wherein the modeler is adapted to determine a data manipulation method associated with completing the processing task.

50. The system of claim 43, wherein the modeler is adapted to select the quantity of processors required for completing the processing task within the desired time period corresponding to at least one of the plurality of processor speeds.

51. The system of claim 43, wherein the modeler is adapted to determine a quantity of variables associated with the processing task.

52. The system of claim 43, wherein the modeler is adapted to determine a length of at least one variable associated with the processing task.
